(19) United States
(12) Patent Application Publication
(10) Pub. No.: US 2011/0208579 A1
(43) Pub. Date: Aug. 25, 2011

(54) SYSTEM FOR GENERATING ADVERTISEMENTS

(75) Inventor: Prabhakaran Krishnamoorthy, Bangalore (IN)

(73) Assignee: Yahoo! Inc., Sunnyvale, CA (US)

(21) Appl. No.: 12/710,122

(22) Filed: Feb. 22, 2010

(51) Int. Cl. G06Q 30/00

(52) U.S. Cl. 705/14.45; 705/14.72; 705/14.55

(57) ABSTRACT

A system for generating advertisements includes a communication interface to obtain a user entry for creating an advertisement. A data memory is coupled with the communication interface. The data memory stores the user entry. A processor is coupled with the data memory. In accordance with the user entry, the processor generates an advertisement, where the advertisement is made available for immediate display to a public.

### TECHNICAL FIELD

The present description relates generally to a system and method, generally referred to as a system, for generating and displaying advertisements.

### BACKGROUND

A market exists for the distribution of advertising and other information over data communications and entertainment networks. A non-limiting example is insertion of advertising copy supplied by advertisers, for appearance on web pages content offered by media distributors such as news and information services, Internet service providers, and suppliers of products related to the advertiser's products or services.

Currently advertisers may create advertisements and submit them to advertisement marketing agencies for serving. These advertisements are reviewed before serving them to the public. Laws may prevent showing certain advertisement and to certain groups. Also companies may have their own rules for displaying advertisements. For example, adult and gambling advertisements typically cannot be shown to those less than 18 years old. Also, in India sex detection during pregnancy related advertisements are not allowed.

Marketing agencies may validate content by flagging potentially inappropriate advertisements and then manually validating and/or editing them. The validation/editing may take couple of days or more. The time lost to such validation may create a lost opportunity. In addition, if an advertiser is going to spend a small amount for the advertisement, then there may be no incentive for the advertisement marketing agency to allocate resources to review, validate and edit the advertisements.

### SUMMARY

A system for generating advertisements includes a communication interface to obtain a user entry for creating an advertisement. A data memory is coupled with the communication interface. The data memory stores the user entry. A processor is coupled with the data memory. In accordance with the user entry, the processor generates an advertisement, where the advertisement is made available for immediate display to a public.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a network environment and system for distributing advertisement impressions.

FIG. 2 is a flow/block diagram illustrating a method and system to support a marketing relationship among advertisers, an ad distribution system, an advertisement creation system, and media outlets.

FIG. 3 is a flowchart/block diagram of a process of creating an advertisement with the system, such as the ad creation system.

FIG. 4 is an exemplary partial screenshot of categories and sub-categories presented to a user.

FIG. 5 is an exemplary processing system for executing the advertisement impression distribution systems and methods.

### DETAILED DESCRIPTION

An advertisement creation system and method, generally referred to as system, may aid users, such as advertisers, in creating advertisements. The system may automatically turn product or service solicitations into advertisements. With the system manual editing of the advertisement may be avoided. The system may make the advertisement available for immediate serving of on-line advertisements to a public. The system may accommodate less expense creation of advertisements than for typical advertising systems. The system may also accommodate the creation of advertisement by users that do not possess a great deal expertise in creating advertisements.

The system may be used by all types of advertisers, and may particularly be useful to small sized companies and individual advertisers that do not typically create many advertisements compared to larger companies. The advertisements provided by the system may create more views by potential customers and more opportunities for the advertisers to sell to the customers, than if the system were not used. Since the system aids users, it may bring in more users than may typically advertise, especially, for example, in developing markets and for individual users who sometimes engage in buying and selling products and services over the Internet. This may in turn generate more revenue opportunities for the service provider, such as Yahoo!, serving the advertisements. The system may also accommodate less expensive monitoring of advertisement content by the service provider which may in turn reduce costs of advertisement.

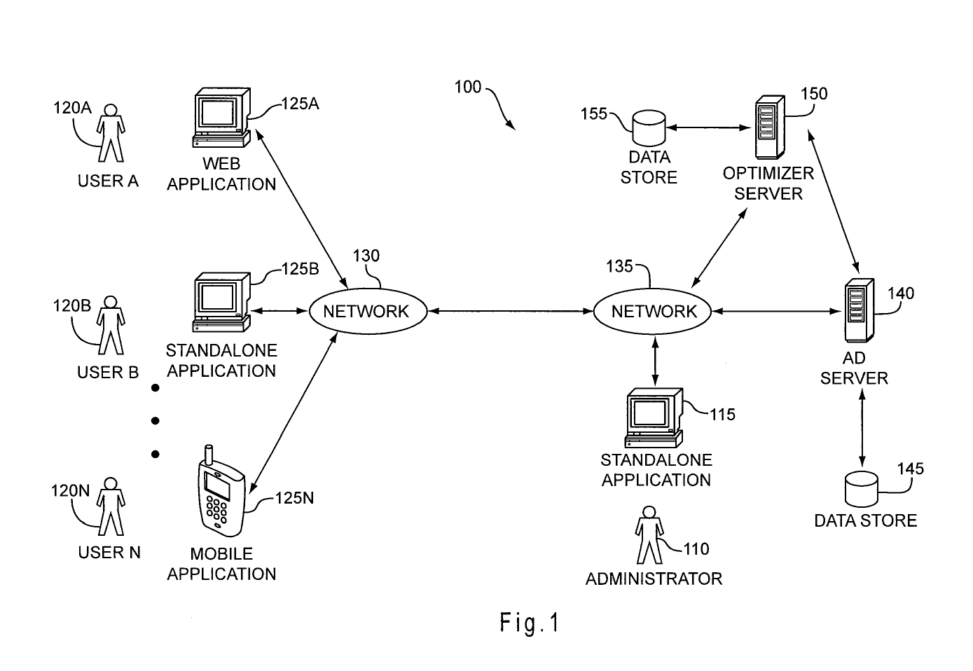

FIG. 1 provides a simplified view of a network environment 100 for serving advertisements, such as on-line advertisement impressions, using the advertisement creation system. Not all of the depicted components may be required, however, and some implementations may include additional components not shown in the figure. Variations in the arrangement and type of the components may be made without departing from the spirit or scope of the claims as set forth herein. Additional, different or fewer components may be provided. The advertisements may be composed of words, sounds, links to web-pages, graphics, etc.

The network environment 100 may include an administrator 110 and one or more users 120A-N with access to one or more networks 130, 135, and one or more web applications, standalone applications, mobile applications 115, 125A-N, which may collectively be referred to as client applications. The network environment 100 may also include one or more advertisement servers 140 and related data stores 145, and one or more optimizer servers 150 and related data stores 155. The users 120 A-N may request pages, such as web pages, via the web application, standalone application, mobile application 125 A-N, such as web browsers. The requested page may request an advertisement impression from the advertisement server 140 to fill a space on the page. The advertiser server 140 may serve one or more advertisement impressions to the pages in accordance with delivery instructions from the optimizer server 150. Alternatively, the advertiser server 140 generates delivery instructions, and an optimizer server 150 is not used. The advertisement impressions may include online graphical advertisements, such as in a unified marketplace for graphical advertisement impressions. Some or all of the advertisement server 140, the optimizer server 150, and the one or more web applications, standalone application, mobile applications 115, 125A-N, may be in communication with each other by way of the networks 130 and 135.

The optimizer server 150 may use a machine learning algorithm. The algorithm may track which advertisements are performing well and in which markets. The optimizer server 150 may also track how advertisements are doing among various races, sexes, age groups, etc. The optimizer server 150 may also ensure that all advertisement get an opportunity for serving. Based on a success among various criteria the advertisement may be classified and grouped. If an advertisement is doing well then the advertisement may be ranked higher and if a advertisement is not doing well then the probability of that advertisement being served may decrease.

The networks 130, 135 may include wide area networks (WAN), such as the Internet, local area networks (LAN), campus area networks, metropolitan area networks, or any other networks that may allow for data communication. The network 130 may include the Internet and may include all or part of network 135; network 135 may include all or part of network 130. The networks 130, 135 may be divided into sub-networks. The sub-networks may allow access to all of the other components connected to the networks 130, 135 in the system 100, or the sub-networks may restrict access between the components connected to the networks 130, 135. The network 135 may be regarded as a public or private network connection and may include, for example, a virtual private network or an encryption or other security mechanism employed over the public Internet, or the like.

The web applications, standalone applications and mobile applications 115, 125A-N may be connected to the network 130 in any configuration that supports data transfer. This may include a data connection to the network 130 that may be wired or wireless. Any of the web applications, standalone applications and mobile applications 115, 125A-N may individually be referred to as a client application. The web application 125A may run on any platform that supports web content, such as a web browser or a computer, a mobile phone, personal digital assistant (PDA), pager, network-enabled television, digital video recorder, such as TIVO®, automobile and/or any appliance or platform capable of data communications.

The standalone application 125B may run on a machine that includes a processor, memory, a display, a user interface and a communication interface. The processor may be operatively connected to the memory, display and the interfaces and may perform tasks at the request of the standalone application 125B or the underlying operating system. The memory may be capable of storing data. The display may be operatively connected to the memory and the processor and may be capable of displaying information to the user B 125B. The user interface may be operatively connected to the memory, the processor, and the display and may be capable of interacting with a user B 120B. The communication interface may be operatively connected to the memory, and the processor, and may be capable of communicating through the networks 130, 135 with the advertisement server 140. The standalone application 125B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, ADOBE FLEX®, amongst others.

The mobile application 125N may run on any mobile device that may have a data connection. The data connection may be a cellular connection, a wireless data connection, an internet connection, an infra-red connection, a Bluetooth connection, or any other connection capable of transmitting data. For example, the mobile application 125N may be an application running on an APPLE IPHONE®.

The advertisement server 140 may include one or more of the following: an application server, a mobile application server, a data store, a database server, and a middleware server. The advertisement server 140 may exist on one machine or may be running in a distributed configuration on one or more machines. The advertisement server 140 may be in communication with the client applications 115, 125A-N, such as over the networks 130, 135. For example, the advertisement server 140 may provide a user interface to the users 120A-N through the client applications 125A-N, such as a user interface for inputting search requests and/or viewing web pages. Alternatively or in addition, the advertisement server 140 may provide a user interface to the administrator 110 via the client application 115, such as a user interface for managing the data source 145 and/or configuring advertisements.

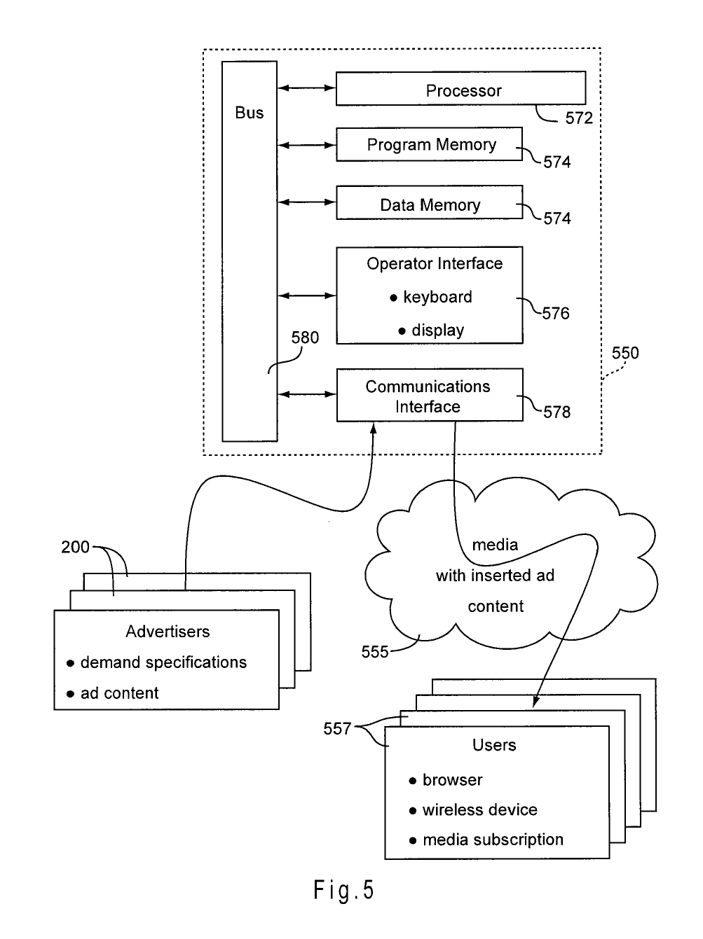

The service provider server 140 and client applications 115, 125A-N may be one or more computing devices of various kinds, such as the computing device in FIG. 5. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 125A may employ the Hypertext Transfer Protocol (“HTTP”) to request information, such as a web page, from a web server, which may be a process executing on the advertisement server 140.

There may be several configurations of database servers, application servers, mobile application servers, and middleware applications included in the advertisement server 140. The data store 145 may be part of the advertisement server 140 and may be a database server, such as MICROSOFT SQL SERVER®, ORACLE®, IBM DB2®, SQLITE®, or any other database software, relational or otherwise. The application server may be APACHE TOMCAT®, MICROSOFT IIS®, ADOBE COLDFUSION®, or any other application server that supports communication protocols.

The networks 130, 135 may be configured to couple one computing device to another computing device to enable communication of data between the devices. The networks 130, 135 may generally be enabled to employ any form of machine-readable media for communicating information from one device to another. Each of networks 130, 135 may include one or more of a wireless network, a wired network, a local area network (LAN), a wide area network (WAN), a direct connection such as through a Universal Serial Bus (USB) port, and the like, and may include the set of interconnected networks that make up the Internet. The networks 130, 135 may include communication methods by which information may travel between computing devices.

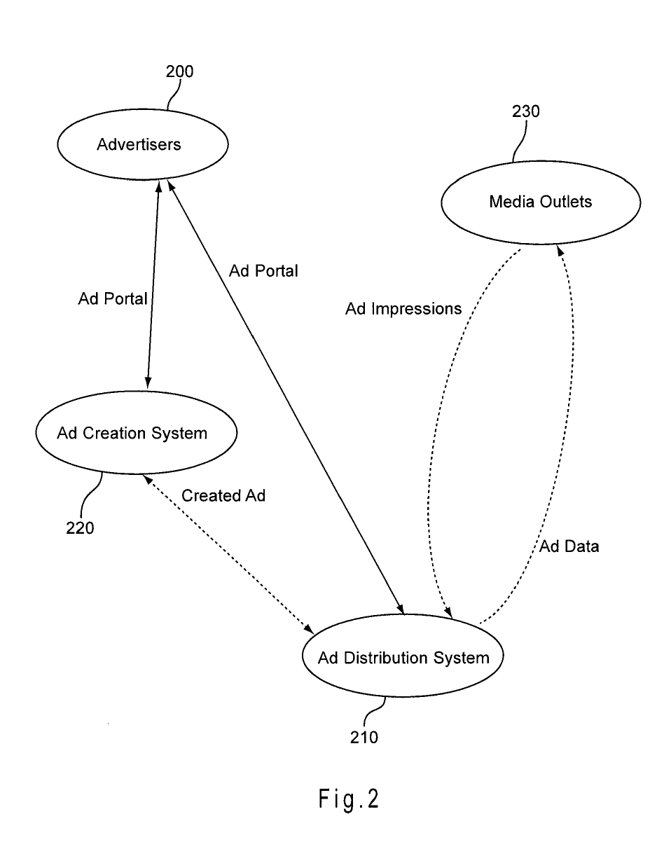

FIG. 2 is a flow/block diagram illustrating a method and system to support a marketing relationship among advertisers 200, an ad distribution system 210, an advertisement creation system 220, and media outlets 230. Advertisers 200 may desire to create an advertisement to advertise a product or service, or both. The advertisers 200 may study their products, commission surveys, collect information from actual customers and so forth, to identify likely targets for ads for a particular product or ads written perhaps to be appealing to some recipients more than others. The advertisers 200 may have various rules for associating ads with ad impressions of distinct types, and for distributing ads generally over various subsets of a population, not necessary limited to applying their advertising expenditures only to certain targeted subsets. The rules and associations may make up a representative profile that can be unique to an advertiser or an advertised product. Advertisers may create an advertisement and submit it to the advertisement distribution system 210 such as via online advertising portals. Before showing the advertisement to the public, e.g., serving the ad, the advertisement may have to be validated, such as manually. It may take few days for getting the advertisement approved.

In addition, or alternatively, the advertiser may utilize the ad creation system 220 to create the advertisement in an easier and quicker way. The advertiser need not have any special knowledge or talent for creating advertisements. With the ad creation system 220, manual editing of the advertisement may be avoided and the system may make the advertisement available to the ad distribution system 210 for immediate serving to a public. Immediate includes making the advertisement available for display without taking the step of reviewing the advertisement for manual editing before allowing the advertisement to be displayed.

Buyers and sellers may use the ad creation system 220 such as to solicit products and/or services. The solicitations may be converted into advertisements and they may be posted, for example, on websites such as www.Craigslist.org or Yahoo! Classified, etc. The advertisements may be created and posted immediately to the public, without the need for further review before posting them. For example, if the buyer is interested in a Honda Civic with less than 100K miles that costs less than 3K, the buyer may post the requirements on a website, such as a solicitation in various websites. The buyer may also use the ad creation system 220 to run the requirements as an advertisement. Such advertisers/advertisements may be small and dynamic compared to other advertisers/advertisements. The advertisements may be displayed for a determined time period, such as for a day or two. The cost and budgets for the advertisements may be less than they are for traditional advertising.

Once the goal of the user is achieved, such as selling/buying a car, the advertisement display may be ended. The ad creation system 220 may guide the user to create an advertisement. The ad creation system 220 may query the user/advertiser about various questions regarding goals of the user, like how soon the user wants to buy or sell the product or service, at what price, how long the user is willing to wait, features of the product or service, etc. The ad creation system 220 may use the information gathered from the query to find out potential customer groups and their profiles. For example, based on the received information, the ad creation system 220 may suggest that the advertisement be served to viewers of an age group between 20 and 28 years old, who are male and live on the East coast of America, as being a target of interest. The ad creation system 220 may also create the advertisement or advertisements that is being sent to target the selected group or groups.

The advertisements may include display advertisements and search marketing advertisements. In the case of a display advertisement the advertiser may be charged per impression of the advertisement. In the case of a searching marketing advertisement the advertiser may be charged based on the user's click. In the case of a display advertisement, irrespective of the user's action the advertiser may be charged for each display of the advertisement. In both cases, if user clicks the advertisement, the advertisement may send the user to a website hosting information about the product and service of the advertiser.

Data regarding the advertisement may be sent to the media outlets 230 to run the advertisement. An agreement to exploit the ad impressions may rely partly on an estimation of the number and character of ad impressions that arise. The media outlets 230 also collect information about their user base and the patterns of user access to and usage of media of one content or another. The media outlets have knowledge of the content of the media and also have knowledge of their users' patterns of access. The media outlets may have subscriber information such as location and demographic data. Some subscriber information can be inferred from a user's access to certain content. This information may be collected and used to study and associate patterns of subscribers and content so as to provide knowledge of the opportunities available to insert advertising that may be of interest to users. Machine learning algorithms may be used to study performance of advertisements under various parameters.

If a media outlet is reasonably certain that a given number of ad impressions of a given type arise, then the media outlet can commit contractually to using the ad impressions to meet the demand of particular advertisers whose representative profile encompasses ad impressions of that type. In an advertising contract, it is possible for parties to agree to a “best efforts” obligation to produce exploitable ad impressions, but a contract containing obligations to produce a certain number and type of ad impressions may be preferable. In that case, the guaranteed ad impressions (guaranteed deliver GD ads) may command a better price than potential ad impressions that might be subject to contract but are not guaranteed (non-guaranteed delivery NGD ads) and are uncertain to arise at all. This situation may be handled in advertising systems by selling guaranteed ad impressions in advance, and selling the additional ad impressions that may arise under different contractual provisions and effectively in a substantially independent market. In addition or alternatively, the advertisement may be charged per a click basis. The advertisement may be shown as a text advertisement as part of regular search, such as a display or banner advertisement. In either scenario advertisement may be charged based on click.

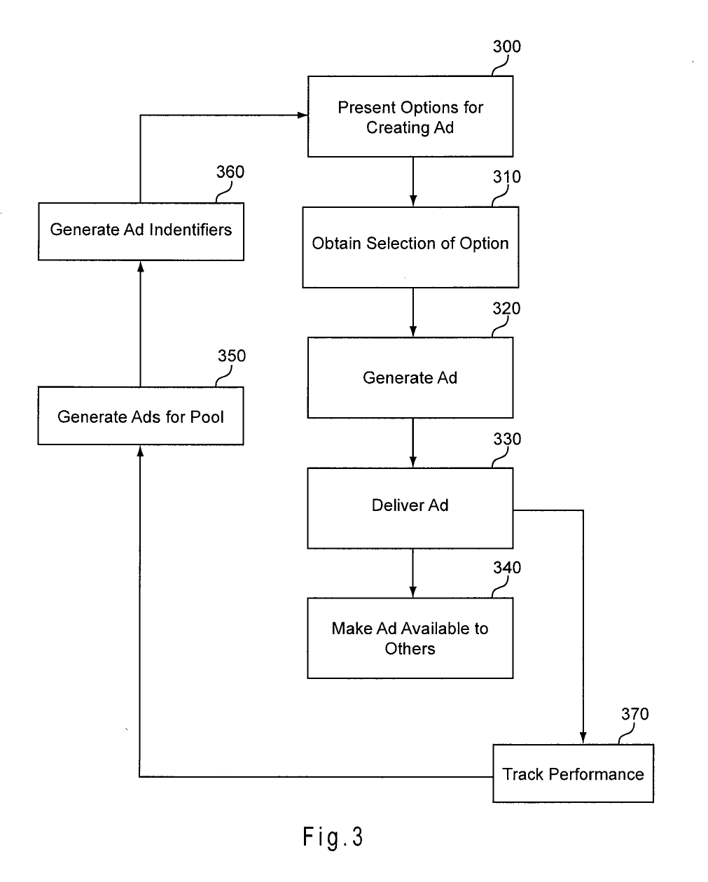

FIG. 3 is a flowchart/block diagram of a process of creating an advertisement with the system, such as the ad creation system 220. The advertisement may be created in accordance with a user's entry, such as a solicitation and other requirements like urgency, cost, quality, etc. An advertiser may choose an advertisement create option to create advertisements. At block 300, the user may be provided with options for creating the advertisement. For a given domain or segment, e.g., automobiles, cosmetic, toys for kids of age group 3 to 6, etc., of a product, the user may be offered options for creating and generating advertisements. Options include a static advertisement, a static advertisement plus, a partially dynamic advertisement, a dynamic advertisement, an auto pilot option, etc.

With static advertisements, the service provider such as Yahoo! may prepare stock advertisements in advance. The user may select the advertisement from a list of advertisements. These advertisements may be created by an expert, such as in that business domain. These advertisements may be complete and ready to use for a given scenario. The completed advertisements do not require any validation by advertisement distribution agency such as Yahoo! and/or they have been pre-validated. Each advertisement may include a rating, such as adult, gambling, clean, etc. The advertisement servers may ensure adult and gambling related advertisements so not serve to inappropriate audience. The system may ensure to give necessary assistance to select suitable advertisement for serving. Also each advertisement may include a targeted age group, sex, race, location, time period to serve, etc. Automatically those options may be applied. In some cases the user may have an option to override the system selected options. In addition, the user may combine available text, sound, graphics, etc. to create the advertisement. All the static items may have been created and certified in advance by the service provider or another entity.

For the static advertisement plus option, the service provider prepares static advertisements with a few optional items, such as fill in the blanks. The user may have the option to fill in additional items using items selected from the list. For example, the user may insert “sporty” into an item “______car”. Additionally and/or alternatively, the user could substitute items with their choice of words. The user may fill the missing items with appropriate words, music, graphics, etc. A filter may be used to automatically filter words, graphics etc. that were determined in advance to be not appropriate. The user may combine text, sound, graphics, etc. to create the advertisement. There may be a restriction such that some combinations are not allowed. In some cases certain combinations have to be included together. For example, if an advertiser chooses to advertise for a religious festival, then the advertiser cannot chose a text which is identified as being derogatory.

The service provider may provide the option for the user to create a partially dynamic advertisement. For the partially dynamic advertisement, the service provider may provide the users with a predetermined list of words and the user may select and combine the various available words to create the advertisement. Also the system may include constraints such that certain words have to appear together. Additionally or alternatively, the system may include constraints such that if certain words appear then some other words are not to appear. Additionally or alternatively, the system may include constraints that for selected products certain words have to appear in the created advertisement. Such inclusion/exclusion rules may apply to audio, video and graphics. Each component may be an individual item. Complete audio components may be created by combining various available audio components. The same may apply to video, graphics and text.

With the dynamic advertisement option, a user may generate an advertisement using their own tool or buy it from third party advertising agencies and post it to a service provider. The service provider may review the user generated advertisement and approve it, or if rejected then report reasons for the rejection. The advertiser may correct the requested items and submit again. Also, some components may be brought from external resource and use service provider provided components to build a complete advertisement. For example, an advertiser may purchase graphics from some advertising agency and use other components like music, text, etc. from the service provider such as Yahoo! to create an advertisement. User may then submit the advertisement to the system for approval and serving. The user may also submit the advertisement to an advertisement pool for other users to use. The approved advertisement may then be selected later for use.

For the auto pilot option, the user may enable the service provider to review a solicitation of the user, and to create one of more advertisement based on the information contained in the solicitation and make it available for serving. The service provider's machine learning algorithm may find a theme or themes of the solicitation and select an appropriate completed advertisement for distribution. The service provider may extract important and interesting theme or items from the solicitation and create advertisements, such as by plugging the information into available templates, or selecting from the standard list to begin showing the advertisement. The advertiser may have their requirements automatically converted into advertisements for serving.

At block 310, the system, such as the ad creation system 220, obtains the user entry. The user entry may include a selected option, product details, intended audience target, etc. In addition or alternatively, the ad creation system 220 may automatically create an advertisement from a solicitation. The request for advertisements and/or solicitations may be submitted to the ad creation system 220 via computer, phone, personal digital assistant, or pager, via a web browser, instant message, or e-mail, either on-line or off-line, such as by sending in a completed hardcopy of a form, etc. The ad creation system 220 may be implemented as part of, or separate from, the ad distribution system 210. The ad distribution system 210 may monitor the delivery and performance of the advertisement, such as to determine how many times the advertisement was viewed.

At block 320, the ad creation system 220 generates various types of advertisements such as text ad, display ad, with/without sound, graphics, etc. The ad creation system 220 may also provide various recommendations and take options such as advertisement target audience, sex, geographic locations, age group, etc.

At block 330, the advertisement may be delivered. The advertisement may be delivered to one or more ad delivery agencies, such as Yahoo!, etc., to media outlets 230, and/or delivered back to the submitter, to be displayed to potential customers. A list of advertisement delivery agencies may be provided to be selected from the master list of advertisement delivery agencies. The list may be maintained by the ad creation system 220. The advertisement may also be displayed directly upon completion. If the user or another created a solicitation, a link may be provided between the user's advertisement and their solicitation.

The advertisement may include details of the product or service. The advertisement may be served onto pages of third party sites or in classified sites like Yahoo! classified and Craig's list. If a viewer clicks the advertisement then the user may be redirected to the corresponding solicitation. After creating the advertisement the service provider may not allow the content of the solicitation to be changed or the service provider may monitor any changes and ensure that any rules with regard to changes are enforced. In some cases the service provider may terminate the advertisement and ask the advertiser to create new set of advertisements if the service provider determines that the changes violate the agreement.

As part of the advertisement a portion of text description may be displayed. One way to provide the description is to link to the viewer to a website solicitation corresponding to the advertiser. Another option may be to display more description of the service or product, such as in a separate window or in the same windows, as soon as user clicks the advertisement. In the case of a group advertisement, the viewer may be redirected to a web page where links to each solicitation and any other required information is made available to the viewer. The service provider may create and provide these links.

Alternatively or in addition to generating advertisements, the system may also be used to generate improved and/or proven solicitations. The system may select, and/or allow the user to select, solicitations from the list that matches the given description. Available templates may be used to generate new solicitations, such as described above with regard to creating advertisements. If the user desires to post a solicitation, e.g., the user wants a house for rent near downtown San Diego with at least 2000 square feet for less than $4000, then the user may provide information, text and/or other details for creating the solicitation. In some cases, such as dating, more information may be required of the user.

Along with a textual description of the product or service to be purchases or sold, other information, such as requirements, may be furnished. User requirements may include what the advertiser wants to do and how they want to do it, e.g., what to buy, how soon to buy it, a quality, a price, and delivery conditions, etc. In rental example, other details may include a desired move in/move out date, a mode of payment, a contract period, etc. The ad creation system 220 may provide the user with templates for creating the solicitation. The ad creation system 220 may create the solicitation from the template and the user provided information, and/or the user may select a previously completed solicitation from the list of solicitations.

At block 340, newly prepared/generated advertisements and solicitations that differ from previously prepared/generated advertisements and solicitations may be made available to other users. The ad creation system 220 may determine that the newly created advertisement or solicitation is eligible to be part of the advertisement/solicitation pool. The pool of advertisements/solicitations may make it easier for the user to use the ad creation system 220 to create an advertisement/solicitation that may have a positive impact on viewers. With the pool, the user is able to see sample postings from other users, conduct some study of the previous posting, and create an advertisement/solicitation to suit needs of the user.

Based on properties of the created advertisement/solicitation, the ad creation system 220 may add the advertisement/solicitation to an appropriate group and sub-group for ease of finding it later. If the advertisement/solicitation may be reused for different type of product or in different scenarios then it may be converted into a template and added to the template pool. This helps to build the advertisement and template pools. New users may select an advertisement/solicitation from the pools and use them. In addition or alternatively, the user may select a template and utilize the ad creation system 220 to convert the template into an advertisement.

At block 350, such advertisements may be generated and submitted to the advertisement pool by the public and/or private entities. Such advertisements may be collaboratively created. The service provider may offer them some incentive for every use of their advertisement and/or a one-time payment to the creator of the advertisement, solicitation or template. Any payments may be based on factors such as a quality of the advertisement. A quality may be determined, such as by keeping track of a number of views of the advertisement, and/or sales based on views of the advertisement. Alternatively the pool of advertisements may be provided for free like videos in Youtube.com. Anyone may be able to submit their advertisements for advertisers to use. When the user clicks the advertisement, it may automatically be sent to be linked with the user's solicitation.

The service provider may generate advertisements to suit various domains or individual items and post them in the pool. The domain may include business units such as buying/selling used cars, consumer merchandise, electronics, house rentals, etc. Individual items may be specified such as used HP 6930P models. The service provider may also create templates to suit various product types and make them available to the advertiser. To do this the service provider may hire advertisement creating agencies and/or invite the general public to create advertisement for certain product/service domains. Alternatively or in addition, if an advertiser generates an advertisement they may make it available to the pool, such as in exchange for some concession on an advertising cost, etc.

For created advertisements, the ad creation system 220 may provide an option to identify the advertisement as private or public. In case of private advertisements, the ad creation system 220 may provide the advertiser with an option to not supply created advertisements to the pool for other advertisers to use. Publicly generated advertisements may be made available to the other advertisers. The publicly generated advertisements may help the service provider to populate the advertisement pool. Advertisements, solicitations and templates available in the pool may be used for free of cost or may be a paid service to the users of the pool, depending on an implementation.

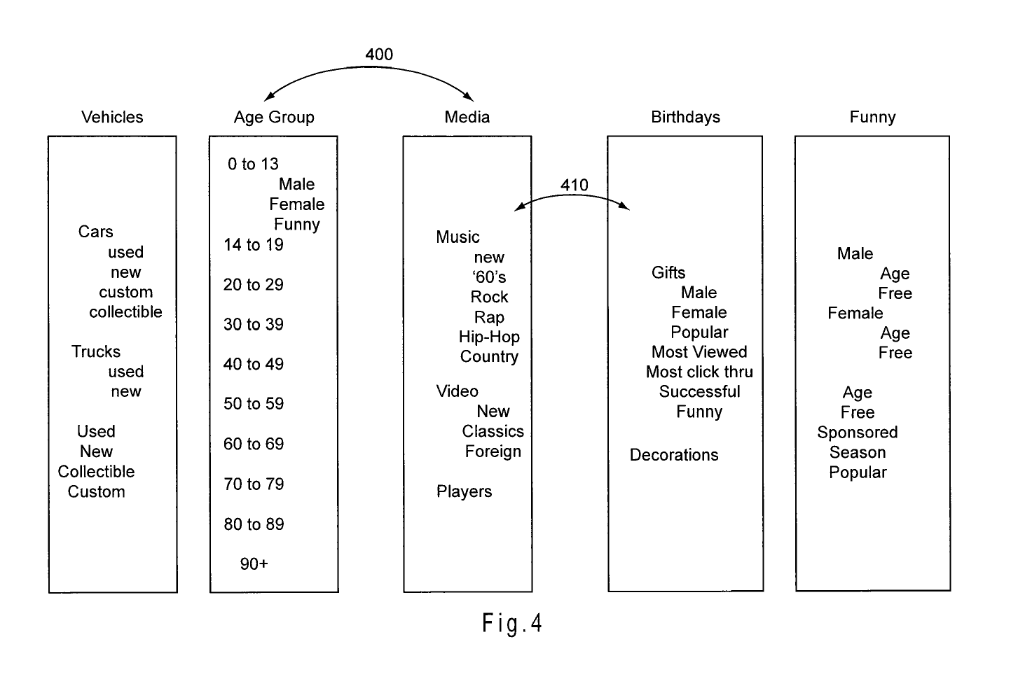

FIG. 4 is an exemplary partial screenshot of categories and sub-categories presented to a user. Referring also to FIG. 3, at block 360, identifiers, such as for domains, and/or a hierarchy of the advertisements in the pool, may be established and displayed to the users. Examples of identifiers 400 include vehicles such as cars, maintenance workers such as carpenters, dating, media such as music, birthday items, etc. Within the cars category there could be sub category 410 such as used, new, custom and collectables, etc. Identifiers such as used, new, custom and collectables may also be categories of their own. Public advertisements may be classified and grouped or sub-grouped according to their content, success ratio, business domain, targeted audience, targeted time and season, etc. Users may browse through the list of advertisements in the pool and select required advertisements. The advertisements may also be classified as advertisements to target certain age group, sex, sexual orientation, related success ratio, geographic location related success, etc. Other identifiers and hierarchies may also be provided such as popular advertisements, funny advertisements, etc. Depending on an advertiser marketing strategy the advertiser may use the ad creation system 220 to select appropriate advertisements for serving.

The advertisements may also be sponsored by other advertisers. If the user is selling books, the user may create an advertisement that includes a link to a store that sells book shelves. The ad creation system 220 may help create the relationship between the user/advertiser and an advertiser of the sub-advertisement for book shelves. The advertiser of book shelves may help create the advertisement of the user selling books in compensation for including the sub-advertisement, or the book shelves advertiser may pay the book advertisers per impression, click though, etc.

At block 370, performance of the advertisements and solicitations may be tracked. In accordance with the tracking, advertisement pool and performance related metrics may be associated with or linked to the advertisements in the pool. The performances may be viewed and ma aid with a selection of the advertisement. The advertisements performance, such as effectiveness of the advertisement to sell the product and/or service, may be monitored and data collected and published with regard to the advertisement. Performance may include rate of success with respect to advertisement click-through rates, popularity among consumers, and/or converting an advertisement into sale, etc. An advertisement's performance with respect to certain age groups, geographic locations, sex, etc. also may be collected and may be used to aid the user and ad creation system 220 in selecting an advertisement. In addition or alternatively, performance metrics may include other factors such as a number of times advertisements are shown, etc.

The ad creation system 220 may also allow users to provide feedback regarding an effectiveness of the selected advertisement to the user. Feedback may also be collected for other factors, such as the amount of time it took to complete the deal, sell the product, sell the service, and how many inquires were generated, etc. The ad creation system 220 may also collect suggestions for improvements to the advertisements and/or to the advertisement creation system as a whole or various components of the system.

The ad creation system 220 may push the selected advertisements to advertiser's accounts with various advertising agencies like Yahoo!, etc. The system may create multiple advertisements and associate them with a single campaign/account, push the advertisement for display, and/or collect performance related metrics about the advertisements. The advertisements may be used to satisfy guaranteed and non-guaranteed contracts of the service provider. In advertisement auto selection mode and advertisement create mode the system may use various parameters like advertisement content, type, target audience profile, geographic location, etc. to select one or more advertisements, such as from the public pool, to market the given product without user intervention. Depending on the performance of the selected advertisements the system may rotate or change the selected advertisements.

With regard to the above ad creation system 220, and other systems, in one example, a user may enter a description of his product or service and what the user wants to achieve, e.g., goals. A goal could be to obtain the best deal, where the user is willing to wait an extended time period, such as a few days, to obtain the best deal. Another goal may be for the user to obtain a fast deal, such as the user needs to buy/sell products and/services as soon as possible. The user may also specify sales to/from certain geographic location or groups with certain specification. Other goals include wanting to spend a reduced rate for the advertisement, etc.

The user can also specify other criteria, such as the user wants to buy car from a single owner whose age is around 60 years; the car needs to be a Honda Civic with fewer than 50K miles; the car price should be less than $10K; the user's advertisement should be shown to around 1000 users; and the user is willing to pay $50 for advertising.

The user may also perform a series of operations using a menu driven system to generate an advertisement. An application could guide the user to create the advertisement. The user may be required enter a minimal amount of entries from which to create the advertisement. By choosing various available options and selecting advertisement components (like text, graphics, video, sound) the user may create the advertisements. From the entered information, the ad creation system 220 generates safe advertisements in terms of content, no copyright violations, adult & gambling, etc. The ad creation system 220 serves the advertisement to an appropriate audience in accordance with the entered criteria and created advertisement, and the advertisement is prepared to meet the rating and specification criteria.

The ad creation system 220 may also aid the user in posting their solicitation in service websites, such as www.craigslist.com and dating sites such as www.dating.com that buy and sell products and services. Generating those solicitations, too, may require creativity to make it attractive to the potential buyer. The ad creation system 220 may create solicitation, rate the solicitation and guide the user to choose right solicitation to meet their need.

The user, such as buyers and sellers, may post their requirements, such as what product/service they want to buy/sell, the quality specification, quantity, etc., to classified section for free or paid sites. Exemplary sites include Yahoo! classified, Craigslist, dating sites, jobs search sites, etc. Other buyer/sellers view the posted solicitation and contact the person listed in the solicitation to complete the buy/sell of the posted product/service. The users may view the solicitation and take appropriate action to buy/sell things.

By advertising the solicitations to those who do not normally view solicitations, more people may view the solicitation than would have otherwise viewed it. The advertising may make it possible to obtain the best deal at the expense of small fee for the advertisement. In one aspect the solicitations may be converted into display advertisement and shown via a cost per impression/display model, or may be shown as a text advertisement as part of search marketing.

In one example, if a user searches for used car, from certain geographic locations, using Yahoo! search, then appropriate used car advertisements may be displayed during the search. This advertisement may have been generated from the solicitation to sell a car. The converted solicitations, if it meets the criteria, may be displayed along with main stream advertisements in sponsored search results. If the user clicks on the advertisement then the advertiser may be charged accordingly, such as under a cost-per-click advertising payment scheme. This kind of facility may help both the advertisers and consumers. Another option may be for the solicitation to be converted to a display advertisement, or banner advertisement, and displayed on various car related sites to invite the users to view the solicitation.

In another example, an advertiser could use the system to create an advertisement without having solicitation, and make the advertisement available for serving. In this case when a viewer clicks the advertisement the viewer may not be redirected to another website. The browser, or any application, may display more information of the clicked advertisement's product/service on the screen. Click display text may be send along with the advertisement. When the advertisement is clicked, the click display text may be shown to the user. Similar to creating an advertisement, the system may help the advertiser in creating solicitations. The ad creation system 220 may guide users to create one or more solicitations which could be posted to any website which hosts the solicitations.

For combined or grouped advertisements, an advertiser may select multiple, but potentially related, solicitations and select the option to create an advertisement for the multiple solicitations. For example, the generated advertisement may not be meant for a single solicitation, but may address multiple solicitations. In job listings a job placement agency may select more than one related profiles from an available list profiles and convert the profiles into one or more group advertisements.

The generated advertisements may be served through various portals such as via the Internet or intranets. Each of the generated advertisements may capture a common theme among the various solicitations and highlight common strengths. When grouped advertisements are clicked the system may enable the user to view all job profiles related to the advertisement, instead of being linked to only one job profile. In another example, the one advertisement may be linked to multiple solicitations. Instead of individual advertisements, a group advertisement may reduce costs. Alternatively or in addition, more than one provider of product and service could combine and create an advertisement to publish. In this case advertisement cost may be a fraction of the original cost.

This disclosure encompasses methods, systems for practicing the methods, programmable data processing apparatus and/or program data carriers that store code enabling a general purpose computer to practice the subject matter when coupled in data communication with sources of advertiser information, sources of media distributor information, and advertising copy that can be inserted when opportunities are reported by the media distributors.

FIG. 5 illustrates a practical embodiment as a block level diagram wherein the ad distribution system is configured as a computer system 550 that is coupled for data communications, for example to provide media in the form of html web pages and graphics files over a communication path traversing the Internet 555 to various remote users 557, who may be appropriate targets for advertising content provided by advertisers 200. The computer system 550 can be associated with a service such as a directory service or search engine, or a retail or wholesale outlet or any of various operations whose activities include transmission of media to users 557.

The system 550 as shown can include one or more processors 572, implemented using a general or special purpose processing engine such as a microprocessor, controller or other control logic configuration. In the example shown, processor 572 is coupled via a bus 580 to program and data memory 574, an interface 576 for input/output with a local operator, including, for example, a keyboard, mouse, display, etc., and a communications interface 578. The communications interface is generally shown coupled for communications with advertisers 200 or over the Internet with remote users 557; however it is likewise possible that other specific techniques could be employed to deliver data from the advertiser to system 550, such as hand transferred data carriers, telephone discussions or even paper exchanges. The manner of transmitting media to the users 557 likewise is not limited to web page data transmission and could comprise, for example cable or other video program distribution among other possible embodiments.

The memory 574 of the computing system advantageously includes random access volatile memory and ROM, disc or flash nonvolatile memory for initialization. The program instructions are stored in and executed from the program memory to carry out the functions discussed above. The memory can include persistent data storage for accumulated data respecting advertiser and user information, for example on hard drives. Advantageously, the memory 574 of system 550 can contain locally stored versions of advertising copy that is to be inserted, especially for servicing guaranteed demand. The memory 574 also can receive, preferably store and insert at least some advertising copy from advertisers 22 who undertake to use ad impressions obtained on the ad hoc spot market.

Alternatively or in addition, at least part of the advertising copy to be inserted can be stored remotely and accessed by providing to the browser at the user system the appropriate URLs identifying advertising content to be inserted. For example, system 550 can store and submit to the user browser a network address for graphics or other content to be inserted, which address refers to a system at or associated with the advertiser 22, which system is coupled for web communications and is configured to respond to an IP request for addressed graphic or media content. That content can be obtained by bidirectional IP communications between the browser and the system where the content is stored

The persistent storage devices of memory 574 may include, for example, a media drive and a storage interface for video or other substantial storage capacity needs. The media drive can include a drive or other mechanism to support a storage media. For example, a hard disk drive, a floppy disk drive, a magnetic tape drive, an optical disk drive, a CD or DVD drive (R or RW), or other removable or fixed media drive may be employed. The storage media can include, for example, a hard disk, a floppy disk, magnetic tape, optical disk, a CD or DVD, or other fixed or removable medium that is read by and written to by the media drive.

The terms “computer program medium” and “computer useable medium” and the like are used generally to refer to media such as, for example, memory 574, various storage devices, a hard disk and hard disk drive and the like. These and other various forms of computer useable media may be involved in carrying one or more sequences of one or more instructions to processor 572 for execution. Such instructions, generally referred to as “computer program code” (which may be grouped in the form of computer programs or other groupings), when executed, enable the computing system 550 to perform features or functions of the embodiments discussed herein.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

The network could be the worldwide web and the advertising copy could comprise banner ads, graphics in fields of specific size and placement, overlaid moving pictures or animation, redirection to a different URL, etc. The same targeting abilities are also applicable to networks that are interactive to a lesser degree, such as cable television ad insertion, which might be done at a head end or at a hub, or even from a subscriber-specific set top box.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A system for generating advertisements, comprising:
a communication interface to obtain a user entry for creating an advertisement;
a data memory coupled with the communication interface, the data memory stores the user selected option; and
a processor coupled with the data memory, where in accordance with the user entry the processor generates an advertisement, where the advertisement is made available for immediate display to a public.

2. The system of claim 1, where the processor associate multiple solicitations to a single advertisement.

3. The system of claim 2, where the processor displays the multiple solicitations when the single advertisement is clicked.

4. The system of claim 1, where the user entry comprises a solicitation for a product or service.

5. The system of claim 4, where the processor links the advertisement to the solicitation.

6. The system of claim 5, where the processor sends a user to the solicitation when the advertisement is clicked.

7. The system of claim 1, where the advertisement is selected from a list of advertisements.

8. The system of claim 1, where the generated advertisement is stored in the data memory for future selection.

9. The system of claim 1, where the advertisement is rated based on a quality of the advertisement.

10. The system of claim 8, where the quality is determined by a number of sales provided by the advertisement.

11. The system of claim 1, where the advertisements are provided free of charge.

12. The system of claim 1, where a performance of the advertisement is associated with the advertisement.

13. The system of claim 1, where the advertisement is generated from pre-approved static items.

14. The system of claim 1, where the advertisement is generated from pre-approved static items and fill-in items.

15. The system of claim 1, where the advertisement is generated from a combination of words selected from a predetermined list of words.

16. The system of claim 1, where the generated advertisement is submitted for immediate approval.

17. The system of claim 1, where the advertisement is generated from themes of a solicitation.

18. A method for generating advertisements, comprising:
obtaining a user entry for creating an advertisement;
storing the user entry in a data entry; and
generating, with a processer, an advertisement in accordance with the user entry, where the advertisement is made available for immediate display to a public.

19. The method of claim 18, further comprising associating multiple solicitations to a single advertisement.

20. The method of claim 19, further comprising displaying the multiple solicitations when the single advertisement is clicked.

21. The method of claim 18, where the user entry comprises a solicitation for a product or service.

22. The method of claim 21, linking the advertisement to the solicitation.

23. The method of claim 22, sending a user to the solicitation when the advertisement is clicked.

24. The method of claim 18, where the advertisement is selected from a list of advertisements.

25. The method of claim 18, where the generated advertisement is stored in the data memory for future selection.

26. The method of claim 18, where the advertisement is rated based on a quality of the advertisement.

27. The method of claim 26, where the quality is determined by a number of sales provided by the advertisement.

28. The method of claim 18, where the advertisements are provided free of charge.

29. The method of claim 18, associating a performance of the advertisement with the advertisement for viewing.

30. The method of claim 18, where the advertisement is generated from pre-approved static items.

31. The method of claim 18, where the advertisement is generated from pre-approved static items and fill-in items.

32. The method of claim 18, where the advertisement is generated from a combination of words selected from a predetermined list of words.

33. The method of claim 18, where the generated advertisement is submitted for immediate approval.

34. The method of claim 18, where the advertisement is generated from themes of a solicitation.
